(19) United States
(12) Patent Application Publication
(10) Pub. No.: US 2013/0098555 A1
(43) Pub. Date: Apr. 25, 2013

(54) ELECTRON BEAM PLASMA SOURCE WITH PROFILED CONDUCTIVE FINS FOR UNIFORM PLASMA GENERATION

(71) Applicants: Kallol Bera, San Jose, CA (US); Shahid Rauf, Pleasanton, CA (US); Ankur Agarwal, Mountain View, CA (US)

(72) Inventors: Kallol Bera, San Jose, CA (US); Shahid Rauf, Pleasanton, CA (US); Ankur Agarwal, Mountain View, CA (US)

(73) Assignee: Applied Materials, Inc., Santa Clara, CA (US)

(21) Appl. No.: 13/595,612

(22) Filed: Aug. 27, 2012

Related U.S. Application Data
(60) Provisional application No. 61/549,365, filed on Oct. 20, 2011.

(51) Int. Cl. H05H 1/46

(52) U.S. Cl. 156/345.35

(57) ABSTRACT

In a plasma reactor employing a planar electron beam as a plasma source, the electron beam source chamber has an internal conductive fin that is profiled along a direction transverse to the beam propagation diction and parallel to the plane of the electron beam, in order to correct electron beam density distribution.

### CROSS-REFERENCE TO RELATED APPLICATIONS

This application claims the benefit of U.S. Provisional Application Ser. No. 61/543,365, filed Oct. 20, 2011 entitled ELECTRON BEAM PLASMA SOURCE WITH PROFILED CONDUCTIVE FINS FOR UNIFORM PLASMA GENERATION, by Kallol Bera, at al.

### BACKGROUND

A plasma reactor for processing a workpiece can employ an electron beam as a plasma source. Such a plasma reactor can exhibit non-uniform distribution of processing results (e.g., distribution of etch rate across the surface of a workpiece) due to nonuniform density distribution of the electron beam. Such non-uniformities can be distributed in a direction transverse to the beam propagation direction.

### SUMMARY

A plasma reactor for processing a workpiece includes a workpiece processing chamber having a processing chamber comprising a chamber ceiling and a chamber side wall and an electron beam opening in the chamber side wall, a workpiece support pedestal in the processing chamber having a workpiece support surface facing the chamber ceiling and defining a workpiece processing region between the workpiece support surface and the chamber ceiling, the electron beam opening facing the workpiece processing region. The reactor further includes an electron beam source chamber comprising a source enclosure, the source enclosure be an electron beam propagation path along a longitudinal direction extending into the workpiece processing region. A conductive fin or an array of conductive fins within the source chamber extends from a back wall toward the electron beam opening, the conductive fin having an edge defining a fin length, the edge having a profile corresponding to a distribution of the fin length along the transverse direction. The distribution of the fin length corresponds to a correction, to a measured distribution in electron beam density along the transverse direction.

### BRIEF DESCRIPTION OF THE DRAWINGS

So that the manner in which the exemplary embodiments of the present invention are attained and can be understood in detail, more particular description of the invention, briefly summarized above, may be had by reference to the embodiments thereof which are illustrated in the appended drawings. It is to be appreciated that certain well known processes are not discussed herein in order to not obscure the invention.

FIGS. 1A, 1B, 1C and 1D are, respectively, a side view, an enlarged side view, a top view and a perspective view of a plasma reactor employing a planar e-beam as a plasma source, and having a profiled (convex) conductive fin protruding into the e-beam source chamber interior, in which the plane of the fin is parallel to the electron beam propagation direction and is parallel to the plane of the e-beam.

FIG. 1E is a top view of a modification of the embodiment of FIG. 1C in which the profiled conductive fin has a concave profile.

FIG. 2 depicts a modification of the embodiment of FIGS. 1A-1D, employing plural parallel conductive fins.

FIGS. 3 and 4 depict modifications of the embodiment of FIGS. 1A-1G, in which the conductive fin has a leading edge that is pointed or rounded, respectively.

FIGS. 5A, 5B and 5C are, respectively, a side view, a perspective view and an end view of an embodiment employing plural parallel planar conductive fins extending from the source chamber ceiling and/or floor, in which the fins are transverse to the plane of the e-beam and transverse to the e-beam propagation direction.

FIG. 6 is a side view of a modification of the embodiment of FIGS. 5A-5C, in which the fins are of different lengths.

FIGS. 7A and 7B are top and perspective views, respectively, of an embodiment employing plural parallel planar conductive, fins extending from the source chamber back wall, in which the fins are transverse to the plane of the e-beam and parallel to the e-beam propagation direction.

FIG. 8 is a top view of a modification of the embodiment of FIGS. 7A and 7B, in which the fins have a triangular or wedge shape.

To facilitate understanding, identical reference numerals have been used, where possible, to designate identical elements that are common to the figures. It is contemplated that elements and features of one embodiment may be beneficially incorporated in other embodiments without further recitation. It is to be noted, however, that the appended drawings illustrate only exemplary embodiments of this invention and are therefore not to be considered limiting of its scope, for the invention may admit to other equally effective embodiments.

### DETAILED DESCRIPTION

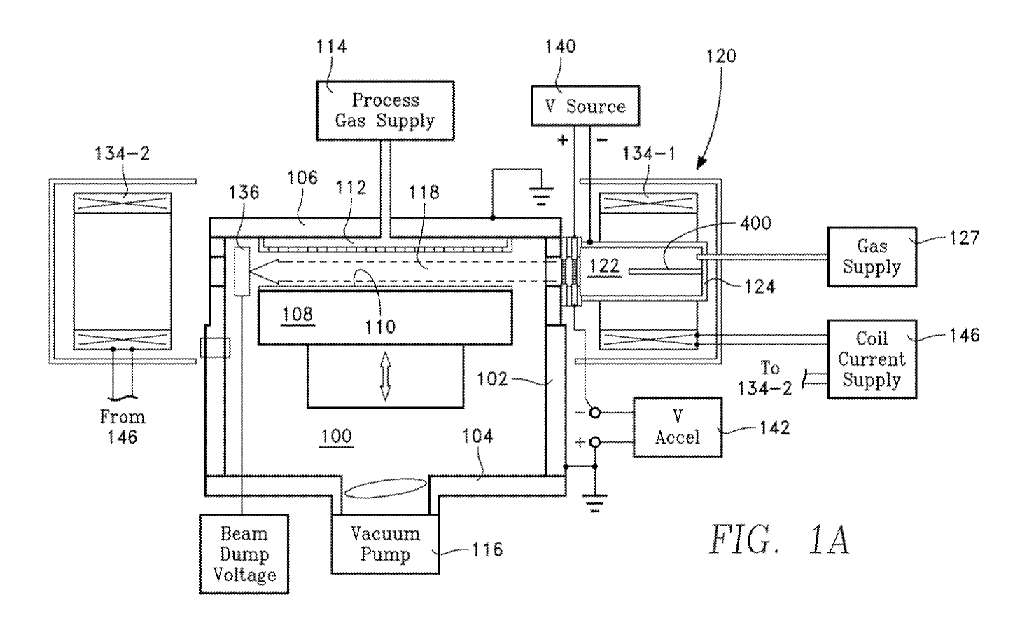

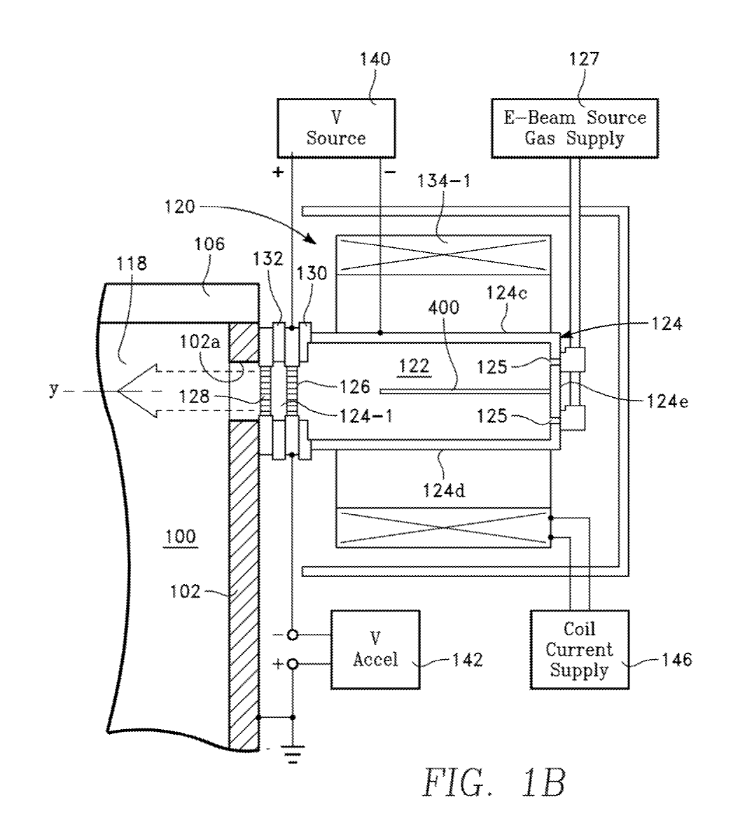

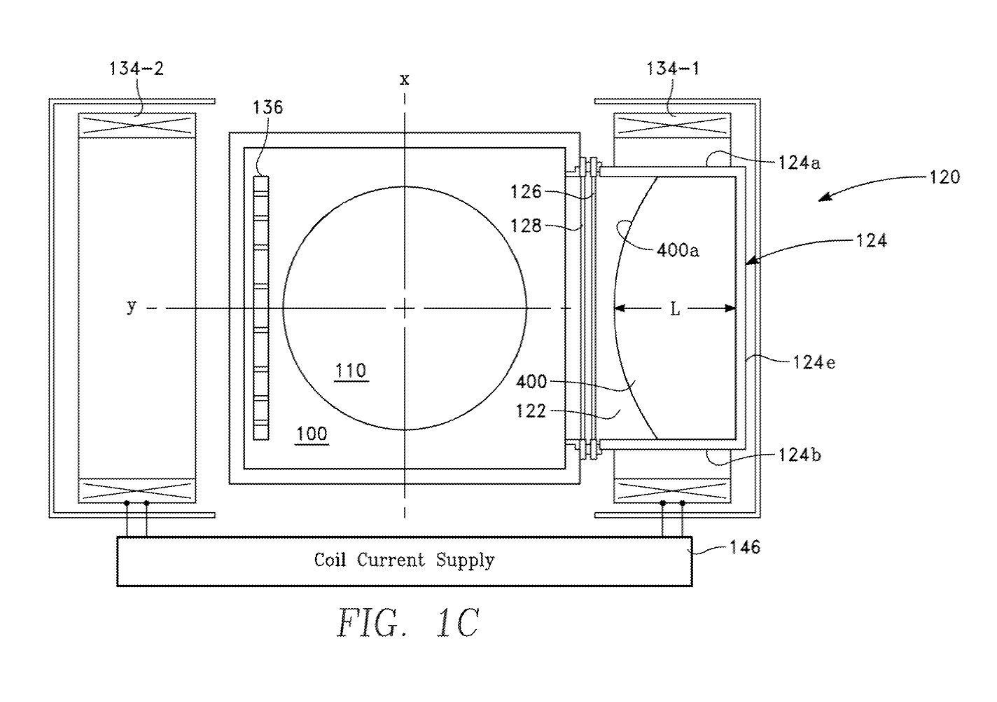

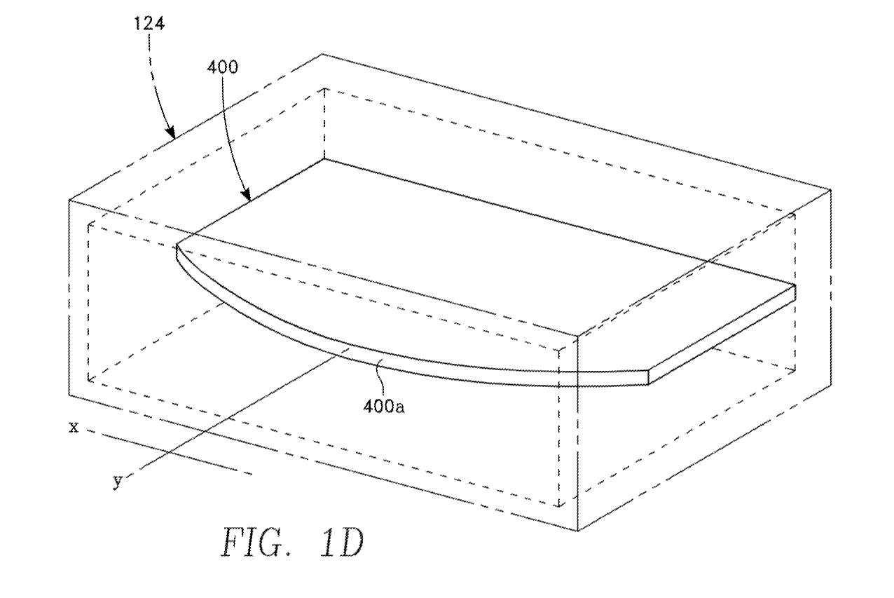

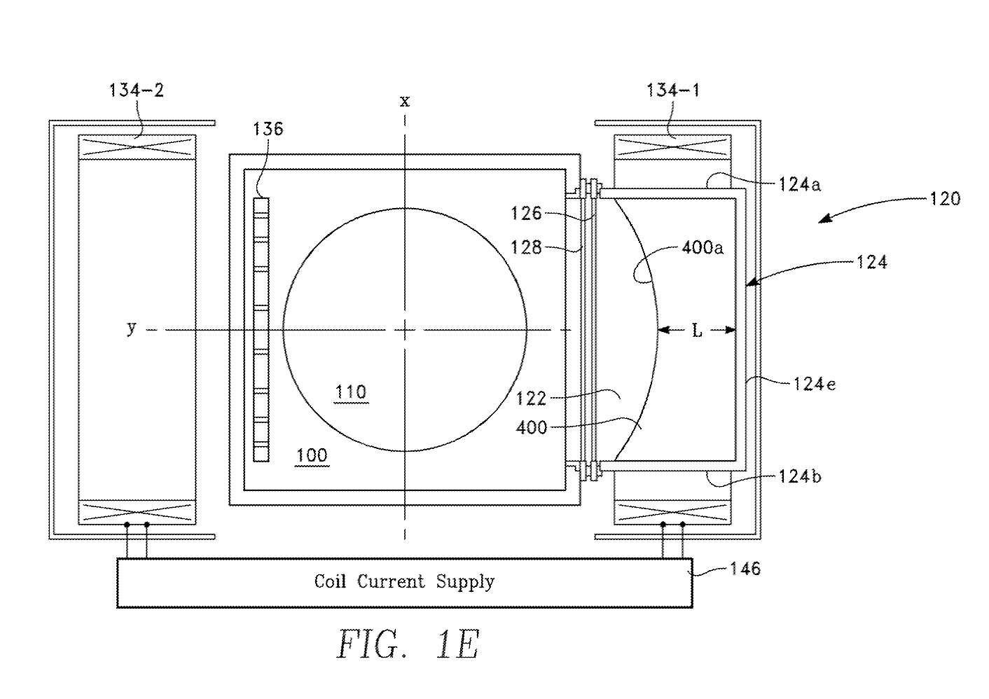

Referring to FIGS. 1A, 1B, 1C and 1D, a plasma reactor has an electron beam plasma source. The reactor includes a process chamber 100 enclosed by a cylindrical side wall 102, a floor 104 and a ceiling 106. A workpiece support pedestal 108 supports a workpiece 110, such as a semiconductor wafer, the pedestal 108 being movable in the axial (e.g., vertical) direction. A gas distribution plate 112 is integrated with or mounted on the ceiling 106, and receives process gas from a process gas supply 114. A vacuum pump 116 evacuates the chamber through the floor 104. A process region 118 is defined between the workpiece 110 and the gas distribution plate 112. Within the process region 118, the process gas is ionized to produce a plasma for processing of the workpiece 110.

The plasma is generated in process region 118 by an electron beam from an electron beam source 120. The electron beam source 120 includes a plasma generation chamber 122 outside of the process chamber 100 and having a conductive enclosure 124. The conductive enclosure 124 may be rectangular and include side walls 124a and 124b, a ceiling 124c, a floor 124d and a back wail 124e. The conductive enclosure 124 has a gas inlet or neck 125. An electron beam source as supply 127 is coupled to the gas inlet 125. The conductive enclosure 124 has an opening 124-1 facing the process region 118 through an opening 102a in the sidewall 102 of the process chamber 100.

The electron beam source 120 includes an extraction grid 126 between the opening 124-1 and the plasma generation chamber 122, and an acceleration grid 128 between the extraction grid 126 and the process region 118, best seen in the enlarged view of FIG. 1B. The extraction grid 126 and the acceleration grid 128 may be formed as separate conductive meshes, for example. The extraction grid 126 and the acceleration grid 128 are mounted with insulators 130, 132, respectively, so as to be electrically insulated from one another and from the conductive enclosure 124. However, the acceleration grid 128 is in electrical contact with the side wall 102 of the chamber 100. The openings 124-1 and 102a and the extraction and acceleration grids 126, 128 can be mutually congruent, and define a thin wide flow path for an electron beam into the processing region 118. The width of the flow path is about the diameter of the workpiece 110 (e.g., 100-500 mm) while the height of the flow path is leas than about two inches. The large aspect ratio of the openings 124-1 and 102a (the ratio of the width to the height) confines the electron beam that is extracted through the openings into a thin planar shape, having a major plane lying along its width and along its direction of propagation. This major plane, or plane of the electron beam, is defined by the intersection of the X-axis (the beam width) and the Y-axis (the beam propagation direction).

The electron beam source 120 further includes a pair of electromagnets 134-1 and 134-2 adjacent opposite sides of the chamber 100, the electromagnet 134-1 surrounding the electron beam source 120. The two electromagnets 134-1 and 134-2 may be symmetrical along the direction of beam propagation, and produces magnetic field parallel to the direction of toe electron beam along an electron beam bath. The electron beam flows across the processing region 118 over the workpiece 110, and is absorbed on the opposite side of the processing region 113 by a beam dump 136. The beam dump 136 is a conductive body having a shape adapted to capture the wide thin electron beam.

A plasma D.C. discharge voltage supply 140 is coupled to the conductive cathode enclosure 124. One terminal of an electron beam acceleration voltage supply 142 is connected to the extraction and 126 and referenced to the ground potential of the sidewall 102 of the process chamber 100. A coil current supply 146 is coupled to the electromagnets 134-1 and 134-2. Plasma is generated within the chamber 122 of the electron beam source 120 by a D.C. gas discharge produced by power from the voltage supply 140, to produce a plasma throughout the chamber 122. This D.C. gas discharge is the plasma source of the electron beam source 120. Electrons are extracted from the plasma in the chamber 122 through the extraction grid 126, and accelerated through the acceleration grid 123 due to a voltage difference between the acceleration grid and the extraction grid to produce an electron beam that flows into the processing chamber 100.

The distribution of electron density along the width of the beam (along the X-axis or direction transverse to beam travel) affects the uniformity of plasma density distribution in the processing region 118. The electron beam may have a non-uniform distribution. Such non-uniformity may be caused by electron drift due to the interaction of the bias electric field with the magnetic field, divergence of electron beam due to electron-electron interactions and/or electron collision with neutral gas in the process chamber. Such non-uniformity may also be caused by fringing of an electric field at the edge, of the electron beam. The distribution of electron density along the width of the beam (along the X-axis or direction transverse to beam travel) is liable to exhibit non-uniformities clue to the forego causes.

A planar thin conductive fin 400 inside the conductive enclosure 124 is attached to the back wall 124e. The plane of the conductive fin 400 is parallel to the beam propagation direction (the Y-axis) and is parallel to the plane of the thin planar electron beam. As discussed above, the electron beam plane is defined by the intersection of the X-axis and the Y-axis. The conductive fin increases the effective area of the interior of the conductive enclosure 124. The conductive enclosure functions as a cathode, while the extraction grid 126 functions as an anode. The increased area provided by the conductive fin 400 increases the ion current to the cathode. In an electron beam source, the electron beam current is balanced by the ion current to the cathode. Therefore, the electron current flowing through the extraction grid 126 increases, thus increasing the electron beam current density or electron beam density. This increase is a function of the length L of the conductive fin 400 along the propagation direction (Y-axis).

A leading edge 400a of the conductive fin 400 defines the fin length L and therefore defines the increase in electron beam current density provided by the conductive fin 400. The length L may be referred to as the fin length. In FIG. 1C the leading edge 400a is profiled in that it is curved, although in other embodiments it may be profiled in a different manner, such as by being stepped, for example. As a result, the fin length L (FIG. 1C), which lies along the beam propagation direction (the Y axis or axial direction) is profiled along the transverse direction (X-axis).

In the embodiment of FIG. 1C (and the perspective view of FIG. 1D), the profile of the conducive fin leading edge 400a is convex, that is, it is longest near its center and shorter at each side edge. In the embodiment of FIG. 1E, the profile of the conductive fin 400 is concave. Specifically, it has the shortest fin length L near its center and the longest fin length at each side edge. In embodiments, the profile of the fin leading edge 400a is such that the distribution of the fin length L along the transverse direction has a variance in excess of 1% or in excess of 5% or in excess of 10%, for example.

Profiling of the conductive fin leading edge 400a affects the electron beam current density distribution along the transverse direction of the electron beam. For example, a longer fin length L at a certain point along the transverse direction increases electron beam current density at that point relative to other locations where the fin length L is shorter. The convex shape of the conductive fin 400 of FIG. 1C tends to render electron beam current density distribution along the transverse direction center high and edge low, and is therefore suitable when the uncorrected distribution is center low. In the embodiment of FIG. 1f, the concave profile of the conductive, in 400 tends to render electron beam current density distribution along the transverse direction center low and edge high, and is therefore suitable when the uncorrected distribution is center high.

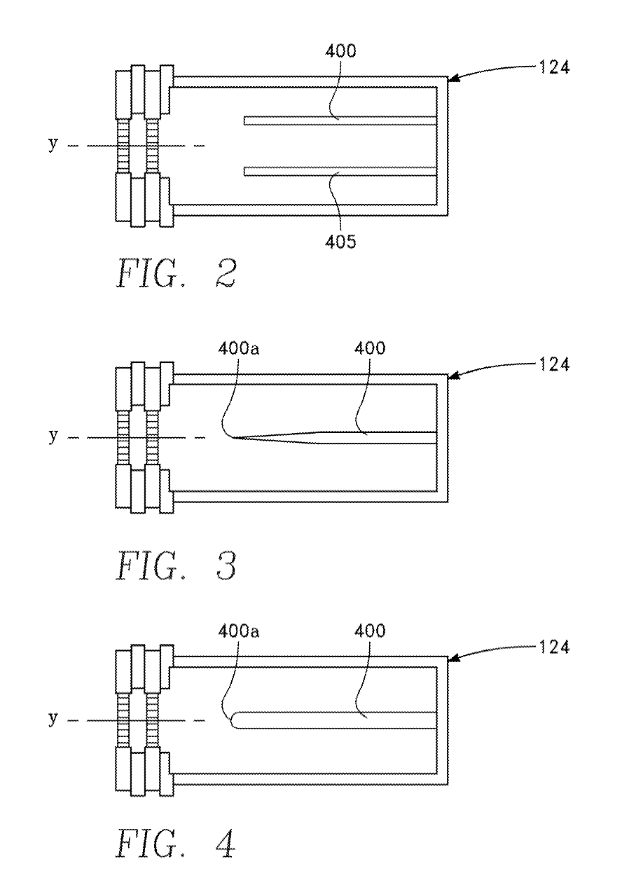

FIG. 2 depicts an embodiment employing an additional conductive fin 405 spaced from and parallel to the conductive fin 400, both fins 400, 405 being parallel to the plane of the electron beam. FIG. 3 depicts an embodiment in which the conductive fin leading edge 400a is pointed. FIG. 4 depicts and embodiment in which the conductive fin leading edge 400a is rounded.

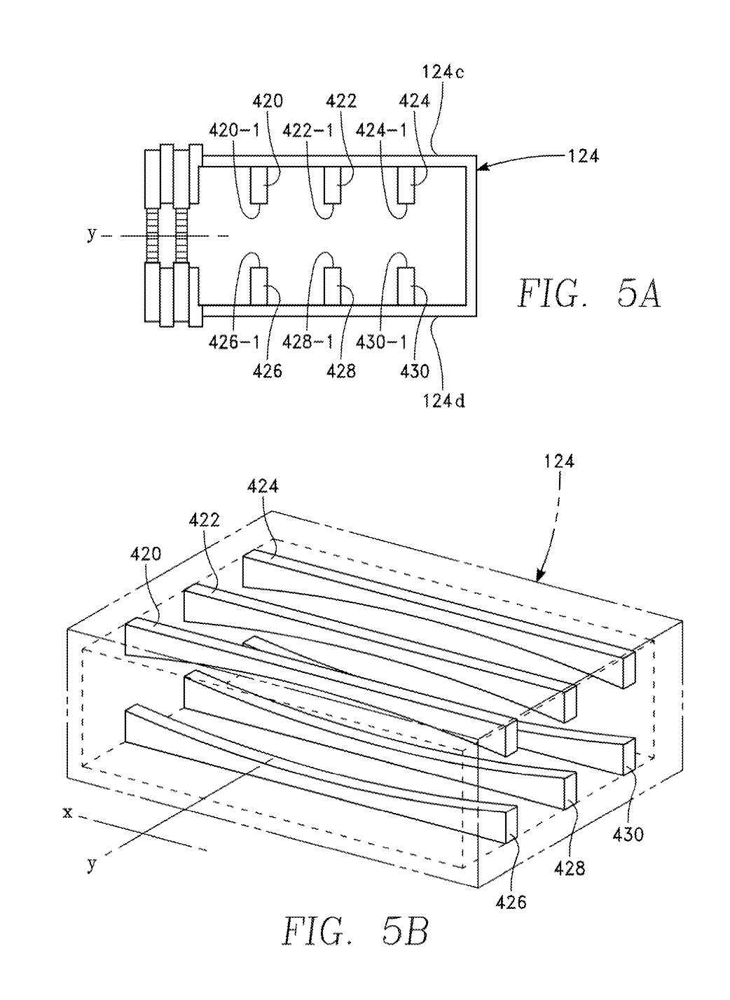

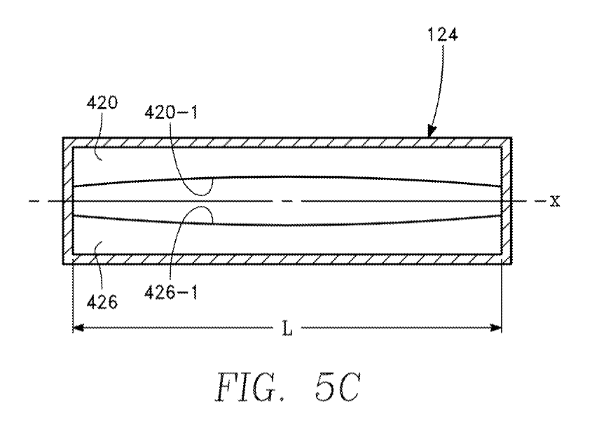

FIGS. 5A, 5B and 5C are side, perspective and end views, respectively of en embodiment in which plural conductive fins 420, 422, 424 extend downwardly from the conductive enclosure ceiling 124c and plural conductive fins 426, 428, 430 extend upwardly from the conductive enclosure floor 124d. The plural fins 420-430 are transverse to the plane, of the electron beam and transverse to the electron beam propagation direction.

The fins 420, 422, 424 that extend from the ceiling 124c are displaced from one another along the electron beam propagation direction and have leading edges 420-1, 422-1, 424-1 that terminate the fins so that they extend only a fraction of the distance between the ceiling 124c and the floor 124d. The fins 426, 428, 430 that extend from the floor 124d are displaced from one another along the electron beam propagation direction and have leading edges 426-1, 428-1, 430-1 that terminate the fins so that they extend only a fraction of the distance between the ceiling 124c and the floor 124d.

As shown in the end view of FIG. 5C, the length L of each of the fins 420-430 is profiled along the X-axis (transverse direction), to adjust or correct electron beam current density distribution along the transverse direction, in the manner previously described.

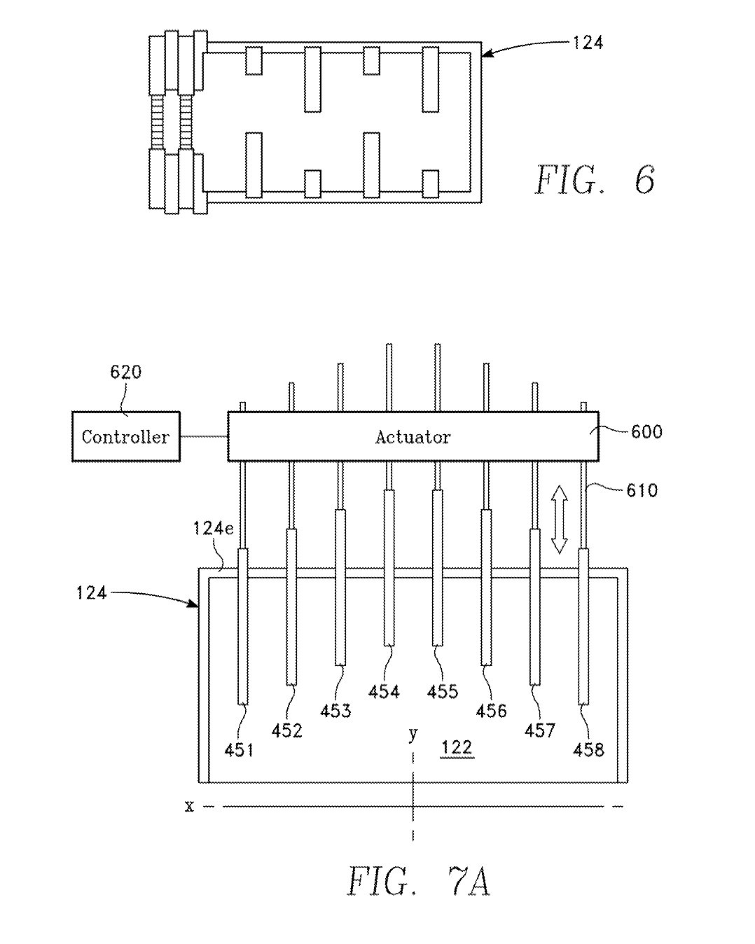

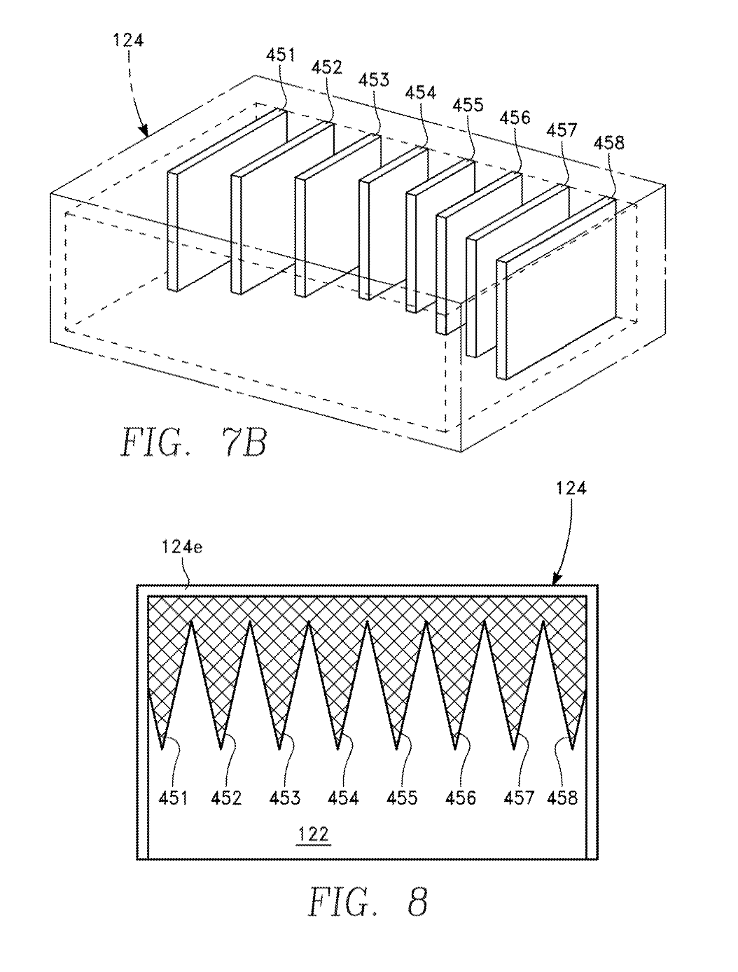

FIG. 6 depicts a modification of the embodiment of FIGS. 5A-5C, in which selected ones of the fins 420-430 have different lengths.

FIGS. 7A and 7B are top and perspective views of an embodiment in which plural parallel conductive fins 451-458 extend from the conductive enclosure back wall 124e and are transverse to the plane of the electron beam and parallel to the electron beam propagation direction. In FIGS. 7A and 7B, the fins 451-458 have different lengths along the Y-axis, and the distribution of these different lengths along the X-axis may be profiled. Such profiling affects the electron beam current density distribution along the transverse direction (X-axis), in the manner previously described for the embodiment of FIGS. 1A-1D. The fine 451-458 may have leading edges that may be straight.

As used herein, the term “fin length” is the length of the portion of particular fin that is exposed to the interior of the conductive enclosure 124. This length may differ depending upon position of each fin, in accordance with a desired profile. FIG. 7A depicts how the array of fins 451-458 may be transformed between different profiles. An actuator array 600 is linked by individually actuated arms 610 to the individual fins 451-458. The fins 451-458 in this embodiment are individually movable along the Y-axis, and may slide within respective slots (not shown) in the conductive enclosure back wall 124e. A controller 620 governing the actuator array 600 enables a user to configure the fins 451-458 in any profile, including the concave profile of FIG. 7A or a convex profile, or a flat profile, for example. The fin profile can be changed with time using the actuator array.

FIG. 8 is a top view of a modification of the embodiment of FIGS. 7A and 7B, in which each one of the conductive fins has a triangular or wedge, cross-sectional shape.

While the main plasma source in the electron beam source 120 is a D.C. gas discharge produced by the voltage supply 140, any other suitable plasma source may be employed instead as the main plasma source. For example, the main plasma source of the electron beam source 120 may be a toroidal RF plasma source, a capacitively coupled RF plasma source, or an inductively coupled RF plasma source.

While the foregoing is directed to embodiments of the present invention, other and further embodiments of the invention may be devised without departing from the basic scope thereof, and the scope thereof is determined by the claims that follow.

What is claimed is:

1. A plasma reactor for processing a workpiece, comprising:
a workpiece processing chamber having a processing chamber comprising a chamber ceiling and a chamber side wall and an electron beam opening in said chamber side wall, a workpiece support pedestal in said processing chamber having a workpiece support surface facing said chamber ceiling and defining a workpiece processing region between said workpiece support surface and said chamber ceiling, said electron beam opening facing said workpiece processing region;
an electron beam source chamber comprising a source enclosure, said source enclosure defining a thin planar electron beam propagation path lying in an electron beam plane along a longitudinal electron beam propagation direction extending through said electron beam opening and into said workpiece processing region, said electron beam plane generally parallel with said workpiece support surface;
a planar conductive fin disposed within said source chamber and extending from wall of said source chamber, said conductive fin having an edge defining a fin length, said edge having a profile corresponding to a distribution of said fin length along said transverse direction.

2. The plasma reactor of claim 1 wherein said distribution of said in length corresponds to a distribution in electron beam density along said transverse direction.

3. The plasma reactor of claim 1 wherein said distribution of said fin length along said transverse direction corresponds to a measured distribution in electron beam density distribution along said transverse direction.

4. The plasma reactor of claim 1 wherein said distribution of said fin length along said transverse direction is center-low, wherein said fin length has a minimum value at a center location of said fin along said transverse direction.

5. The plasma reactor of claim 4 wherein said reactor has a measured distribution of plasma density along said transverse direction that is center-high in absence of said fin.

6. The plasma reactor of claim 1 wherein said distribution of said fin length along said transverse direction is center-high, wherein said gap has a maximum value at a center location of said fin along said transverse direction.

7. The plasma reactor of claim 6 wherein said reactor has a measured distribution of plasma density distribution along said transverse direction that is center-low in absence of said fin.

8. The plasma reactor of claim 1 wherein said distribution of said fin length along said transverse direction has a variance of least 1%.

9. The plasma reactor of claim 1 wherein said distribution of said fin length along said transverse direction has a variance of at least 5%.

10. The plasma reactor of claim 1 wherein said planar conductive fin lies in a fin plane parallel to said electron beam plane and parallel to said electron beam propagation direction, and said fin length is parallel to said electron beam propagation direction.

11. The plasma reactor of claim 10 wherein said wall comprises a back wall of said source enclosure, and said planar conductive fin extends from said back wall along said electron beam propagation direction, wherein said fin comprises one of (a) a single fin, (b) plural parallel conductive fins.

12. Its plasma reactor of claim 1 wherein said planar conductive fin lies in a fin plane transverse to said electron beam plane and transverse to said electron beam propagation direction.

13. The plasma reactor of claim 12 wherein said source enclosure comprises a ceiling and a floor facing said ceiling and being parallel with said electron beam plane, and said wall comprises one of said floor or ceiling, and said fin length is transverse to said electron beam propagation direction.

14. The plasma reactor of claim 13 further comprising plural conductive fins disposed within said source chamber, each of said fins lying in a respective fin plane transverse to said electron beam plane and transverse to said electron beam propagation direction, some of said plural conductive fins extending from said ceiling and remaining ones of said plural conductive fins extending from floor, each of said conductive fins having an edge no a fin length, said edge having a profile corresponding to a distribution of said fin length along said transverse direction.

15. The plasma reactor of claim 14 wherein the fin length of each of said conductive fins extends from the edge of said fin to a corresponding one of said floor or ceiling along a direction transverse to said electron beam propagation direction and transverse to said electron beam plane.

16. A plasma reactor for processing a workpiece, comprising:
a workpiece processing chamber having a processing chamber comprising a chamber ceiling and a chamber side wall and an electron beam opening in said chamber side wall, a workpiece support pedestal in said processing chamber having a workpiece support surface facing said chamber ceiling and defining a workpiece processing region between said workpiece support surface and said chamber ceiling, said electron beam opening facing said workpiece processing region;
an electron beam source chamber comprising a source enclosure, said source enclosure defining a thin planar electron beam propagation path lying in an electron beam plane along a longitudinal electron beam propagation direction extending through said electron beam opening and into said workpiece processing region, said electron beam plane generally parallel with said workpiece support surface; and
plural conductive fins disposed within said source chamber, each of said fins lying in a respective fin plane transverse to said electron beam plane and parallel to said electron beam propagation direction, each of said conductive fins having a respective edge defining a respective fin length, the fin lengths of said fins being profiled along said transverse direction.

17. The plasma reactor of claim 16 wherein said fin lengths are profiled in accordance with one of a concave profile or a convex profile or a flat profile.

18. The plasma reactor of claim 16 wherein each of said conductive fins has a triangular cross-sectional shape.

19. The plasma reactor of claim 16 wherein each of said fins extends from a back wall of said source enclosure in a direction parallel to said electron beam propagation direction.

20. The plasma reactor of claim 19 further comprising plural actuators coupled to respective ones of said plural conductive fins, wherein said plural conductive fins are movable along said electron beam propagation direction.
